(19) United States
(12) Patent Application Publication
(10) Pub. No.: US 2006/0181887 A1
(43) Pub. Date: Aug. 17, 2006

(54) Touch button controlled lamp assembly

(76) Inventor: Shang-Chih Chen, Banqiao City (TW)

Correspondence Address: TROXELL LAW OFFICE PLLC;SUITE 1404, 5205 LEESBURG PIKE, FALLS CHURCH, VA, 22041, US

(21) Appl. No.: 11/058,270

(22) Filed: Feb. 16, 2005

(51) Int. Cl. F21V 23/04; F21S 8/08

(52) U.S. Cl. 362/395; 362/251; 362/411

(57) ABSTRACT

A touch button controlled lamp assembly in which the touch button which can control the on-off operation of the main lamp on the top bracket and the branch lamps along the metal tube. The touch button switch is hidden in the base for the protection purpose, easy for the user to operate. The LEDs in different color are mounted on the top and the button of the acrylic tube to provide amazing beauty and energy saving.

### BACKGROUND OF THE INVENTION

1. Field of the Invention

This invention relates to a touch button controlled lamp assembly in which the main lamp and the branched lamps are mounted on the bracket constructed by metal tube and acrylic tube to achieve sectional control, easy and convenient for the user to operate. The different colored LEDs are mounted at the top and the bottom of the acrylic tube to show off the beautiful vision.

2. Description of the Prior Art

In the prior art of the touch button controlled lamp assembly, the touch button control circuit is encircled in the bracket, incorporated with a power switch to control the on-off operation of the lamp. If there are more than two branch lamps mounted on the bracket, it requires more than one power switches to control the main lamp and the branch lamps, not easy for the user to operate. The lighting brilliance varies as the situation warrants, there is restraint for the user to adjust the proper brilliance by the power switches, so the convenience is greatly minimized.

Besides, the prior art of the touch button controlled lamp assembly is controlled by the button switches or knob switches which are high power consumers with high production cost and not easy for maintenance. The inventor has dedicated with great efforts for years to improve the touch button controller and finally come up with this improved touch button controlled lamp assembly.

### SUMMARY OF THE INVENTION

The main object of this invention is to provide an easily controlled touch button lamp assembly in which the power switches are replaced by several touch button controllers and low voltage transformer to supply required power to the main lamp and the branch lamps. The LEDs are utilized as the night indication lamp. It offers beautiful, vivid decoration and vision and the power consumption is very low to gain the energy saving.

To achieve this object as stated above, the lamp bracket is made from the metal tube and the acrylic tube. The main lamp is placed on the bracket top with the branch lamps encircled along the metal tube. The LEDs are mounted on the upper end and the lower end of the acrylic tube. The acrylic tube is used to isolate the touch button circuit and the touch button controller and the low voltage transformer are housed in the base.

The special features and function of the touch button controller are explained in great detail with the aid of embodiments as illustrated in the attached drawings.

### BRIEF DESCRIPTION OF THE DRAWINGS

FIG. 1 shows the 3-dimensinal scheme of the touch button controlled lamp assembly of this invention.

FIG. 2 shows the disassembly of the touch button controlled lamp assembly of this invention.

### DETAILED DESCRIPTION OF THE PREFERRED EMBODIMENT

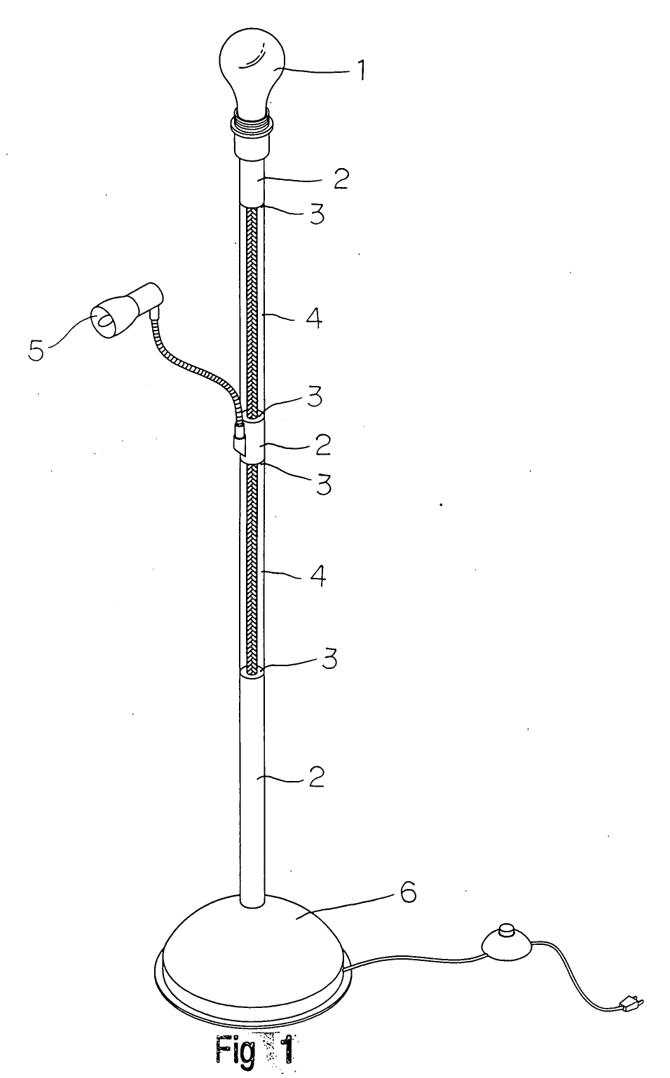

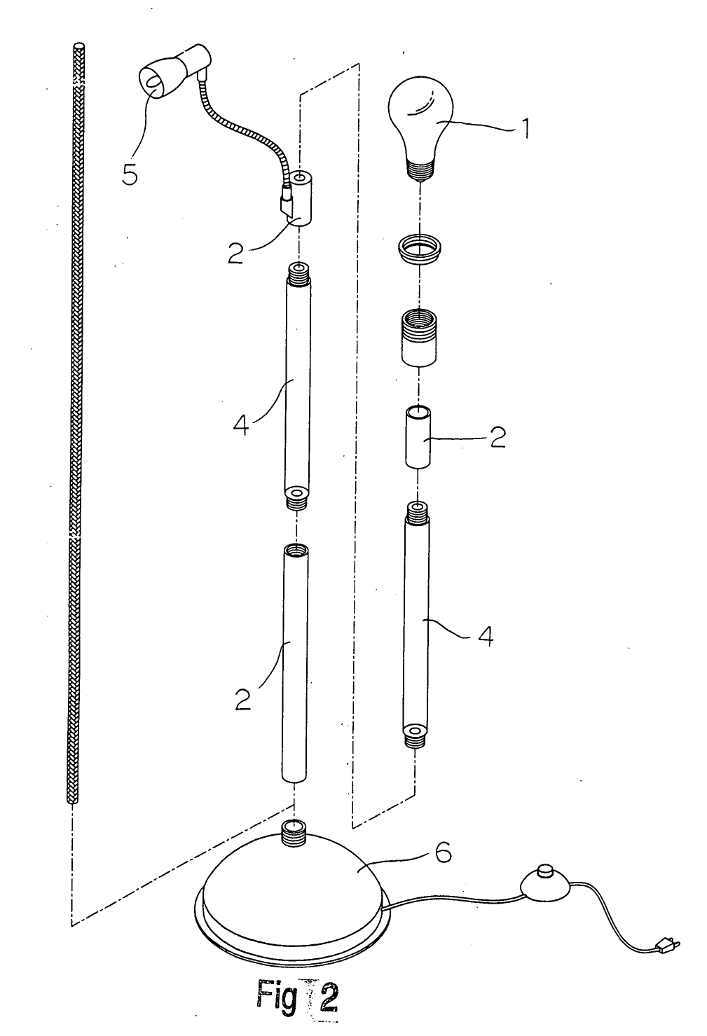

Please refer to FIGS. 1 and 2, the touch button controlled lamp assembly mainly comprises one metal tube (2) and acrylic tubes (4), where the metal tube (2) is separated by the acrylic tubes (4). On the top of lamp bracket, there mounts the main lamp (1) and at the bottom, there is a base (6). The branch lamps (5) are encircled along the metal tube (2). The control circuit is hidden in the acrylic tube (4).

The touch button controllers (not shown) and the low voltage transformer (not shown) are housed in the base (6) employed to control the on-off operation of the main lamp (1), branch lamp (5) and LEDs (3) to hidden and protect the control circuit and low voltage transformer. The low voltage transformer is linked to the metal tube (2) by threads.

The purpose of the acrylic tube (4) is to separate the control circuit from the metal tube (2), so this design offers an easy expedition for controlling the main lamp (1) and the branch lamps (5) and instant maintenance and replacement of worn parts.

The LEDs (3) mounted on the upper end and lower end of the acrylic tube (4) serve not only as the indicative diversification, but also as the colorful decoration. The LEDs (3) work as the night lamp to obtain the energy saving purpose.

It is learned that the touch button controlled lamp assembly embraces the advantages in easy control the on off operation of the main lamp and the branch lamps. The LEDs in varying colors mounted on the acrylic tube (4) render the lamp bracket a beautiful and vivid decoration. This is a novel invention well justified for the grand of the patent.

What is claimed is:

1. A touch button controlled lamp assembly mainly comprises:
The metal tube, more than one piece, on which, the main lamp is mounted on top the branch lamps are encircled along the tube and the control circuit is hidden in the tube.
The acrylic tube, more than one piece, linked to the metal tube by thread, is to isolate the control circuit from the metal tube and the LEDs are mounted on the upper end and the lower end.
Several touch button controllers housed in the base for controlling and turning the main lamp and the branch lamps on or off.
One low voltage transformer is employed to control the on and off operation of the LEDs.

2. The touch button controlled lamp assembly as claimed in the claim 1 in which the acrylic tube is to isolate the metal tube from the control circuit.

3. The touch button controlled lamp assembly as claimed in the claim 1 in which the base is mounted at the lower end of the metal for housing the touch button controller and the low voltage transformer.

4. The touch button controlled lamp assembly as claimed in the claim 1 in which the low voltage transformer is linked to metal tube by means of tread.

5. The touch button controlled lamp assembly as claimed in the claim 1 in which the LEDs mounted at the upper end and the lower end of the acrylic tube can be in different colors.

6. The touch button controlled lamp assembly as claimed in the claim 1 in which the LEDs are allow to be replaced with low voltage bulbs.
